(19) United States
(12) Patent Application Publication
(10) Pub. No.: US 2016/0062015 A1
(43) Pub. Date: Mar. 3, 2016

(54) POLARIZER, DISPLAY PANEL AND FORMING METHOD THEREOF

(71) Applicants: BOE TECHNOLOGY GROUP CO., LTD., Beijing (CN); HEFEI XINSHENG OPTOELECTRONICS TECHNOLOGY CO., LTD, Anhui (CN)

(72) Inventors: Wei YAN, Beijing (CN); Qing ZHANG, Beijing (CN)

(21) Appl. No.: 14/744,406

(22) Filed: Jun. 19, 2015

(30) Foreign Application Priority Data
Sep. 2, 2014 (CN) 201410443045.6

(51) Int. Cl. G02B 5/30

(52) U.S. Cl. CPC G02B 5/3041

(57) ABSTRACT

The present invention provides a polarizer, a display panel and a forming method thereof. The polarizer includes a polarizing film layer and a first bonding layer arranged on the lower surface of the polarizing film layer, wherein the first bonding layer is used for adhesion with a display substrate, the polarizer further includes a second bonding layer arranged on the upper surface of the polarizing film layer, and the second bonding layer is used for adhesion with a first film layer. Since the polarizer is additionally provided with the second bonding layer based on the existing polarizer, the double surfaces of the polarizer can be simply and conveniently adhered to the display substrate and the first film layer respectively, thereby greatly simplifying the adhesion process of the polarizer in a double-face adhesion process.

### FIELD OF THE INVENTION

The present invention relates to the field of display technology, and in particular relates to a polarizer, a display panel and a forming method thereof.

### BACKGROUND OF THE INVENTION

Because of the characteristics of small size, low power consumption, no radiation and the like, a liquid crystal display (LCD) device has become a mainstream product in the current flat panel display devices. A liquid crystal display panel is a key component in the liquid crystal display device.

In order to achieve imaging display of the liquid crystal display panel, polarizers must be attached to the display panel, the main working principle of the polarizers is allowing passage of light vibrating in a specific direction, and only by means of the polarizers attached to the upper and lower panel surfaces of the display panel and having polarization directions perpendicular to each other, the liquid crystal display panel can normally display images.

At present, a touch liquid crystal display panel has become the mainstream of market development. To achieve the touch display function of a traditional non-touch liquid crystal display panel, the easiest way is to integrate a touch panel (TP) on the display panel, for example, a touch panel is added at the outside of the light outgoing side of the display panel, and generally, the touch panel can be attached to the panel surface of the light outgoing side of the display panel. Since the polarizer is arranged on the panel surface of the light outgoing side of the liquid display panel, the touch panel is generally attached to the upper surface of the polarizer.

A structure of the existing polarizer is as shown in FIG. 1. According to the superposition sequence of film layers, the polarizer sequentially includes a first stripping layer 4, a bonding layer 6, a first protective layer 12, a polarizing plate 11, a second protective layer 13 and a second stripping layer 5. In a process of attaching the polarizer to the display panel, the first stripping layer 4 is stripped off at first, and then the polarizer is adhered to the panel surface of the light outgoing side of the display panel through the bonding layer 6. In an attaching process of the touch panel, the second stripping layer 5 on the polarizer is stripped off at first, immediately followed by coating an OCA (Optically Clear Adhesive) on the second protective layer 13, and then the touch panel and the display panel are adhered in an alignment manner. In this way, the touch panel can be attached to the light outgoing side of the display panel through the OCA.

In the attaching process of the touch panel, OCA coating is involved, and the accurate control of such process parameters as the coating uniformity and the coating thickness of the OCA is necessarily involved in the coating process of the OCA, such that the attaching process of the entire touch panel is relatively complicated, and meanwhile the need of mass production of the touch liquid crystal display panel cannot be satisfied.

### SUMMARY OF THE INVENTION

To solve the above technical problems in the prior art, the present invention provides a polarizer, a display panel and a forming method thereof, and a display device. Since the polarizer is additionally provided with a second bonding layer based on the existing polarizer, the double surfaces of the polarizer can be simply and conveniently adhered to a display substrate and a first film layer respectively, thereby greatly simplifying the adhesion process of the polarizer in a double-face adhesion process.

As an aspect of the present invention, a polarizer is provided, including a polarizing film layer and a first bonding layer arranged on the lower surface of the polarizing film layer, wherein the first bonding layer is used for adhesion with a display substrate; the polarizer further includes a second bonding layer arranged on the upper surface of the polarizing film layer, and the second bonding layer is used for adhesion with a first film layer.

The second bonding layer can adopt an OCA, and the first bonding layer can adopt silica gel.

The polarizing film layer may include a polarizing plate, and a first protective layer and a second protective layer, which are respectively attached to the upper and lower surfaces of the polarizing plate.

The polarizer may be further provided with a first stripping layer on the outer side of the first bonding layer, and further provided with a second stripping layer on the outer side of the second bonding layer.

As another aspect of the present invention, a display panel is further provided, including a display substrate and the above-mentioned polarizer, wherein the polarizer is attached to the light outgoing side of the display substrate, and a first film layer is further attached to the side of the polarizer away from the display substrate.

The first film layer may be a touch film layer or a protective film layer.

A surface protective layer may be further attached to the side of the first film layer away from the polarizer.

As a further aspect of the present invention, a display device is further provided, including the above-mentioned display panel.

As a still further aspect of the present invention, a forming method of the above-mentioned display panel is further provided, including:

placing the display substrate on the first bonding layer side of the polarizer, placing the first film layer on the second bonding layer side of the polarizer, and adhering the display substrate, the polarizer and the first film layer in an alignment manner.

Before adhering the display substrate, the polarizer and the first film layer in the alignment manner, the method may further include: stripping off the first stripping layer and the second stripping layer on the polarizer; and after adhering the display substrate, the polarizer and the first film layer in the alignment manner, the method may further include: attaching a surface protective layer to the side of the first film layer away from the polarizer.

After attaching the surface protective layer, the method may further include: debubbling an adhesion surface formed in the alignment adhesion process of the display substrate, the polarizer and the first film layer and an adhesion surface formed in the process of attaching the surface protective layer.

The present invention has the beneficial effects that the polarizer provided by the present invention is additionally provided with the second bonding layer based on the existing polarizer, such that the double surfaces of the polarizer can be simply and conveniently adhered to the display substrate and the first film layer respectively, thus greatly simplifying the adhesion process of the polarizer in a double-face adhesion process.

According to the display panel provided by the present invention, by adopting the above-mentioned polarizer, the adhesion process of the first film layer on the display substrate is greatly simplified and the mass production efficiency of the display panel is improved; meanwhile, the first film layer is adhered to the display substrate more firmly to ensure good performance of the first film layer attached to the display substrate; furthermore, the adhesion of the polarizer to the display substrate is more simply and conveniently.

According to the display device provided by the present invention, by adopting the above-mentioned display panel, the preparation process of the display device is simplified, and the mass production efficiency of the display device is improved.

### BRIEF DESCRIPTION OF THE DRAWINGS

FIG. 1 is a section view of a structure of a polarizer in the prior art.

FIG. 2 is a section view of a structure of a polarizer in embodiment 1 of the present invention.

FIG. 3 is a section view of a structure of a display panel in embodiment 2 of the present invention.

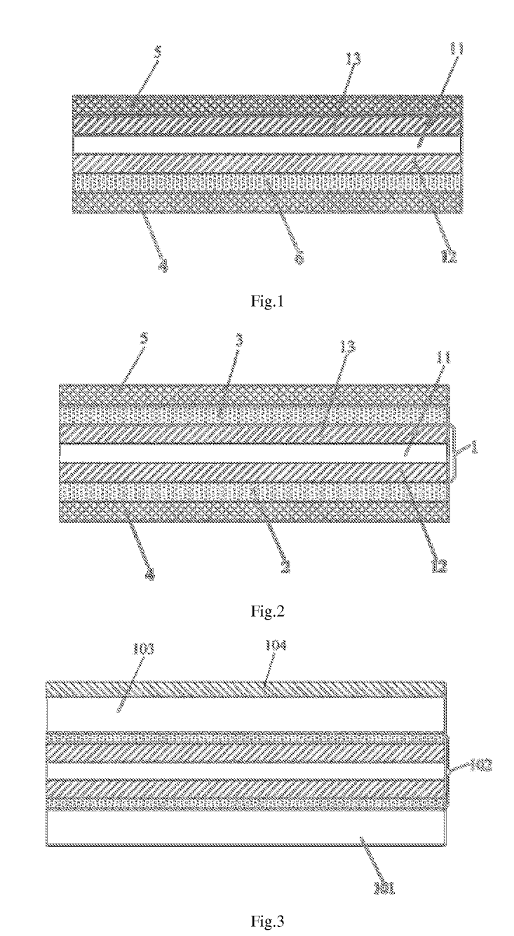

### DETAILED DESCRIPTION OF THE EMBODIMENTS

In order to make those skilled in the art better understand the technical solutions of the present invention, a further detailed description of the polarizer, the display panel and the forming method thereof, and the display device provided by the present invention will be given below in combination with the accompanying drawings and the embodiments. Unless otherwise noted, the “upper” and “lower” directions herein refer to the upper and lower directions in the accompanying drawings.

### Embodiment 1

The embodiment provides a polarizer, as shown in FIG. 2, including a polarizing film layer 1 and a first bonding layer 2 arranged on the lower surface of the polarizing film layer 1, wherein the first bonding layer 2 is used for adhesion with a display substrate; the polarizer further includes a second bonding layer 3 arranged on the upper surface of the polarizing film layer 1, and the second bonding layer 3 is used for adhesion with a first film layer.

In the embodiment, the display substrate refers to a substrate, which is formed by aligning and assembling an array substrate and a color film substrate to form a cell, with no polarizer substrate attached thereto. The first film layer may be a touch film layer (namely a touch panel) or a protective film layer. The protective film layer can protect the display substrate.

Due to arrangement of the first bonding layer 2 and the second bonding layer 3, the double surfaces of the polarizer can be simply and conveniently adhered to the display substrate and the first film layer respectively, thus greatly simplifying the adhesion process of the polarizer with the display substrate and the first film layer, wherein the first film layer may be the touch film layer (namely the touch panel). Of course, the first film layer may also be some other protective film layers used for protecting the light outgoing surface of the display substrate.

In the embodiment, the second bonding layer 3 adopts an OCA (Optically Clear Adhesive), and the first bonding layer 2 adopts silica gel. The OCA is also called an optically clear adhesive, which has excellent properties such as excellent clarity, high light transmittance (all-optical penetration rate >99%), high adhesive force, high weather resistance, water resistance, high temperature resistance, ultraviolet resistance, and does not generate yellowing (yellow stain), stripping and deterioration after long time use. Therefore, the second bonding layer 3 adopting the OCA is very suitable for adhering the touch film layer. Silica gel has high adsorptive property, good thermal stability, stable chemical property and higher mechanical strength, so that it is very suitable for adhering the polarizer to the display substrate.

In the embodiment, the polarizing film layer 1 includes a polarizing plate 11, and a second protective layer 13 and a first protective layer 12, which are respectively attached to the upper and lower surfaces of the polarizing plate 11. The polarizing plate 11 is made from a PVA (polyvinyl alcohol) material, and both of the first protective layer 12 and the second protective layer 13 are made from a TAC (Triacetyl Cellulose) material, wherein since the polarizing plate 11 made from the PVA material is very liable to hydrolyze, to protect the physical properties of the polarizing plate 11, the first protective layer 12 and the second protective layer 13 are respectively attached to the both sides of the polarizing plate 11, and the first protective layer 12 and the second protective layer 13 made from the TAC material have high light transmittance, good water resistance and certain mechanical strength, thereby being capable of well protecting the polarizing plate 11.

In the embodiment, the polarizer is further provided with a first stripping layer 4 on the outer side of the first bonding layer 2, and the polarizer is further provided with a second stripping layer 5 on the outer side of the second bonding layer 3. The first stripping layer 4 and the second stripping layer 5 can respectively protect the first bonding layer 2 and the second bonding layer 3, and when the first bonding layer 2 and the second bonding layer 3 of the polarizer are respectively adhered to the display substrate and the first film layer, the first stripping layer 4 and the second stripping layer 5 are stripped off.

Embodiment 1 has the beneficial effects that the polarizer in embodiment 1 is additionally provided with the second bonding layer based on the existing polarizer, such that the double surfaces of the polarizer can be simply and conveniently adhered to the display substrate and the first film layer respectively, thus greatly simplifying the adhesion process of the polarizer in a double-face adhesion process.

### Embodiment 2

The embodiment provides a display panel, as shown in FIG. 3, including a display substrate 101 and the polarizer 102 in embodiment 1, wherein the polarizer 102 is attached to the light outgoing side of the display substrate 101, and a first film layer 103 is further attached to a side of the polarizer 102 away from the display substrate 101.

In the embodiment, the display substrate 101 refers to a substrate, which is formed by aligning and assembling an array substrate and a color film substrate to form a cell, with no polarizer substrate attached thereto. The first film layer 103 is a touch film layer (namely a touch panel) or a protective film layer. The protective film layer can also protect the light outgoing surface of the display substrate 101.

In the embodiment, a surface protective layer 104 is further attached to a side of the first film layer 103 away from the polarizer 102. The surface protective layer 104 can protect the first film layer 103 to prevent the first film layer 103 from being scratched or collided.

The embodiment further provides a forming method of the above-mentioned display panel, including:

Step S1: stripping off the first stripping layer and the second stripping layer on the polarizer.

At this time, the first bonding layer and the second bonding layer on the polarizer are exposed.

Step S2: placing the display substrate on the first bonding layer side of the polarizer, placing the first film layer on the second bonding layer side of the polarizer, and adhering the display substrate, the polarizer and the first film layer in an alignment manner.

Due to such operation, the first bonding layer and the second bonding layer can be used for conveniently adhering the first film layer to the display substrate. Compared with the forming method of the display panel in the prior art, in the forming method of the display panel in the embodiment, a step of coating an OCA on the existing polarizer is omitted, and the polarizer is directly adhered to the first film layer, so that the adhesion process of the display panel is greatly simplified to simplify the entire process flow of forming the display panel.

In the embodiment, the above-mentioned forming method further includes step S3: attaching a surface protective layer to a side of the first film layer away from the polarizer. In the step, the surface protective layer is directly adhered to the first film layer, and in general, as long as it is ensured that no air enters the mutual joint surfaces of the surface protective layer and the first film layer, the surface protective layer can be firmly attached to the first film layer.

In addition, after step S3, the above-mentioned forming method further includes step S4: debubbling the adhesion surfaces formed in step S2 and step S3, namely, squeezing out air bubbles between the adhesion surfaces by pressure to ensure the tight and firm adhesion of the adhesion surfaces and ensure the normal exertion of the functions of the adhered film layers at the same time.

Embodiment 2 has the beneficial effects that by adopting the polarizer in embodiment 1, the adhesion process of the first film layer on the display substrate is greatly simplified and the mass production efficiency of the display panel is improved; meanwhile, the first film layer is adhered to the display substrate more firmly to ensure good performance of the first film layer attached to the display substrate; furthermore, the adhesion between the polarizer and the display substrate is more simply and conveniently.

### Embodiment 3

The embodiment provides a display device, including the display panel in embodiment 2.

By adopting the display panel in embodiment 2, the preparation process of the display device is simplified, and the mass production efficiency of the display device is improved.

The display device provided by the present invention may be any product or component having a display function, such as a liquid crystal panel, a liquid crystal television, a display, a mobile phone, a navigator, etc.

It should be understood that, the above embodiments are merely exemplary embodiments adopted for describing the principle of the present invention; however, the present invention is not limited thereto. Various modifications and improvements can be made by the person skilled in the art without departing from the spirit and essence of the present invention, and these modifications and improvements are interpreted as being encompassed within the protection scope of the present invention.

1. A polarizer, comprising a polarizing film layer and a first bonding layer arranged on the lower surface of the polarizing film layer, wherein the first bonding layer is used for adhesion with a display substrate, the polarizer further comprises a second bonding layer arranged on the upper surface of the polarizing film layer, and the second bonding layer is used for adhesion with a first film layer.

2. The polarizer of claim 1, wherein the second bonding layer adopts an OCA, and the first bonding layer adopts silica gel.

3. The polarizer of claim 2, wherein the polarizing film layer comprises a polarizing plate, and a first protective layer and a second protective layer, which are respectively attached to the upper and lower surfaces of the polarizing plate.

4. The polarizer of claim 1, wherein the polarizer is further provided with a first stripping layer on the outer side of the first bonding layer, and the polarizer is further provided with a second stripping layer on the outer side of the second bonding layer.

5. A display panel, comprising a display substrate and a polarizer, wherein the polarizer is attached to the light outgoing side of the display substrate, a first film layer is further attached to the side of the polarizer away from the display substrate, the polarizer comprises a polarizing film layer and a first bonding layer arranged on the lower surface of the polarizing film layer, the first bonding layer is used for adhesion with a display substrate, the polarizer further comprises a second bonding layer arranged on the upper surface of the polarizing film layer, and the second bonding layer is used for adhesion with a first film layer.

6. The display panel of claim 5, wherein the second bonding layer adopts an OCA, and the first bonding layer adopts silica gel.

7. The display panel of claim 6, wherein the polarizing film layer comprises a polarizing plate, and a first protective layer and a second protective layer, which are respectively attached to the upper and lower surfaces of the polarizing plate.

8. The display panel of claim 5, wherein the polarizer is further provided with a first stripping layer on the outer side of the first bonding layer, and the polarizer is further provided with a second stripping layer on the outer side of the second bonding layer.

9. The display panel of claim 5, wherein the first film layer is a touch control film layer or a protective film layer.

10. The display panel of claim 9, wherein a surface protective layer is further attached to the side of the first film layer away from the polarizer.

11. A forming method of a display panel, wherein the display panel comprises a display substrate and a polarizer, the polarizer is attached to the light outgoing side of the display substrate, a first film layer is further attached to the side of the polarizer away from the display substrate, the polarizer comprises a polarizing film layer and a first bonding layer arranged on the lower surface of the polarizing film layer, the first bonding layer is used for adhesion with a display substrate, the polarizer further comprises a second bonding layer arranged on the upper surface of the polarizing film layer, and the second bonding layer is used for adhesion with a first film layer,
wherein the method comprises:
placing the display substrate on the first bonding layer side of the polarizer, placing the first film layer on the second bonding layer side of the polarizer, and adhering the display substrate, the polarizer and the first film layer in an alignment manner.

12. The forming method of the display panel of claim 11, wherein the polarizer is further provided with a first stripping layer on the outer side of the first bonding layer, and the polarizer is further provided with a second stripping layer on the outer side of the second bonding layer,
wherein before adhering the display substrate, the polarizer and the first film layer in the alignment manner, the method further comprises: stripping off the first stripping layer and the second stripping layer on the polarizer; and
after adhering the display substrate, the polarizer and the first film layer in the alignment manner, the method further comprises: attaching a surface protective layer to the side of the first film layer away from the polarizer.

13. The forming method of the display panel of claim 12, wherein after attaching the surface protective layer, the method further comprises: debubbling an adhesion surface formed in the alignment adhesion process of the display substrate, the polarizer and the first film layer and an adhesion surface formed in the process of adhering the surface protective layer.
